(19) United States
(12) Patent Application Publication
(10) Pub. No.: US 2017/0046791 A1
(43) Pub. Date: Feb. 16, 2017

(54) Systems and methods for budget analysis visualization

(71) Applicant: Valepro, LLC, Huntsville, AL (US)

(72) Inventors: Craig Arthur Runnels, Madison, AL (US); Candace A. Runnels, Madison, AL (US)

(73) Assignee: Valepro, LLC, Huntsville, AL (US)

(21) Appl. No.: 15/235,063

(22) Filed: Aug. 11, 2016

Related U.S. Application Data
(60) Provisional application No. 62/203,720, filed on Aug. 11, 2015.

(51) Int. Cl. G06Q 40/00; G06F 3/0481

(52) U.S. Cl. CPC G06Q 40/125; G06F 3/0481

(57) ABSTRACT

A system of the present disclosure has a budget analysis data server communicatively coupled to a budget analysis collection system and a process that receives budget analysis characteristic data from a budget analysis collection system and stores the budget analysis characteristic data in resident memory. Additionally, the processor receives an input from a user identifying budget analysis characteristic data the user desires to view, translates the budget analysis characteristic data into at least one geometric shape based upon the user's input, and displays the at least one geometric shape to an output device.

### CROSS REFERENCE TO RELATED APPLICATION

This application claims priority to U.S. Provisional Patent Application Ser. No. 62/203,720 entitled Budget Analysis Tools and Methods and filed on Aug. 11, 2015, which is incorporated herein by reference in its entirety.

### BACKGROUND

Government and contracting entities often have to engage in a very labor intensive effort to collect, understand, and exploit financial data related to government projects. The findings are often an integral part of the development of business and contracting opportunities.

As an example, Federal Government contractual opportunities often are compiled from an inordinate amount of data. The details regarding the contractual opportunities specifically are often difficult to ascertain due to the voluminous information associated therewith. Notably, monetary flows, either historical or current, are even more difficult to ascertain due to the complex nature of Federal Government contracting.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram depicting a budget analysis visualization system in accordance with an embodiment of the present disclosure.

FIG. 2 is a block diagram of an exemplary control center computing device depicted in FIG. 1.

FIG. 3 is an exemplary graphical user interface (GUI) of the budget analysis visualization system depicted in FIG. 1.

FIG. 4A is an Agency GUI of FIG. 3 showing a child window displaying budget analysis characteristic data.

FIG. 4B is a subdepartment Catalog GUI of FIG. 3 showing a zoom selection window.

FIG. 4C is a GUI showing geometric shapes resulting from a zoom of the data shown in FIG. 4B.

FIG. 4D is a GUI showing geometric shapes resulting from a zoom of the data shown in FIG. 4C.

FIG. 4E is the GUI in FIG. 4D showing a selection information child window related to a budget line item shown in the GUI of FIG. 4D.

FIG. 4F is a project GUI showing a selection information child window.

FIG. 4G is a GUI showing a child window comprising detailed project information from drilling down in FIG. 4F.

FIG. 5 is a flowchart of exemplary architecture and functionality of the control logic depicted in FIG. 2.

### DETAILED DESCRIPTION

Embodiments of the present disclosure generally pertain to systems and methods for space budget analysis visualization. A system in accordance with one exemplary embodiment of the present disclosure automates visualization of characteristics of particular financial programs, and the automated visualization conveys to a user various characteristics related to a plurality of financial programs that are monitored by the system. In particular, the exemplary system for budget analysis visualization receives budget line item (BLI) characteristic data indicative of characteristics of a particular budget from a BLI data server and translates the received budget analysis characteristic data into graphical representations of the BLI characteristics, which are displayed to a graphical user interface.

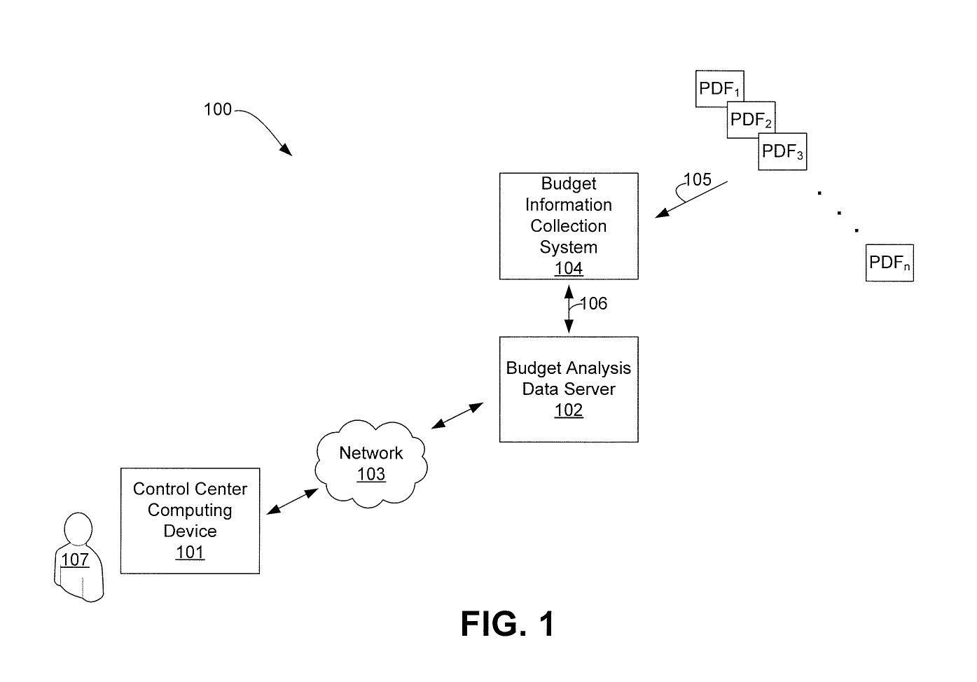

FIG. 1 is a block diagram of a budget analysis visualization system (BAVS) 100 in accordance with an embodiment of the present disclosure. The BAVS 100 comprises a resident budget information collection system 104 that detects characteristics related to a plurality of programs, including BLIs. In this regard, a budget information collection system either receives periodically or requests files, typically in the form of a portable document format (PDF) file, PDF1-PDFn that contains all information related to a particular program contained within a particular budget.

While a single budget information collection system 103 is shown in FIG. 1, this is merely for exemplary purposes only. There are numerous systems that may be employed that can collect the relevant program data. Thus, for purposes of the present disclosure, the budget information collection system 104 is any type of system known in the art or future-developed that can retrieve or request program related information.

In one embodiment, the budget information collection system 104 translates the PDFs received into a parseable document. For example, the system 104 may translate the information contained in each PDF to any type of format that is readable and parseable.

The system 100 further comprises a budget analysis data server 102. The a budget analysis data server 102 is any type of computing device that receives and stores data obtained or measured by the budget information collection system 104 via the communication link 106. The communication link 106 may be effectuated by via a network or a direct connection. The system 100 further comprises a control center computing device 101 that is communicatively coupled to the budget analysis data server 102. Note that in the exemplary system 100 shown in FIG. 1, the control center computing device 101 is communicatively coupled to budget analysis data server 102 via a network 103. However, the control center computing device 101 may also be communicatively coupled to the budget analysis data server 102 via a direct communication link.

In operation, the budget information collection system 104 collects and translates the PDF characteristic data related to a plurality of programs, for example government programs that contain budget line items (BLI). As described hereinabove, many different types of technologies may be used to collect the program characteristic data. Thus, the present disclosure encompasses any type of known or future-developed system and/or device that collects and translates the program characteristic data that is received in PDF format.

The business analysis data server 102 receives the program characteristic data collected, and stores the data resident on the budget analysis data server 102. In one embodiment, the budget analysis data server 102 may request program characteristic data from the budget information collection system 104. In another embodiment, the budget information collection system 104 may periodically download the program characteristic data to the budget analysis data server 102. Whether requested or periodically downloaded, the program characteristic data is provided to the budget analysis data server 102 via the communication link 106.

In one embodiment, the control center computing device 101 specifically requests program characteristic data from the budget analysis data server 102. In another embodiment, the budget analysis data server 102 periodically downloads program characteristic data to the control center computing device 101. In either embodiment, upon receipt the control center computing device 101 stores the received program characteristic data resident on the control center computing device 101.

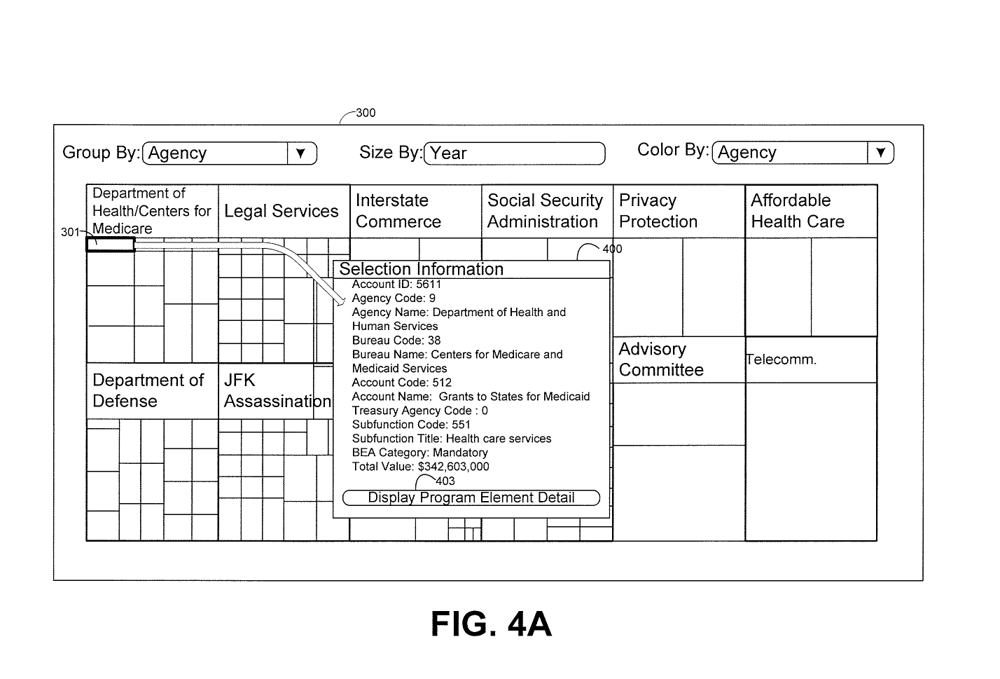

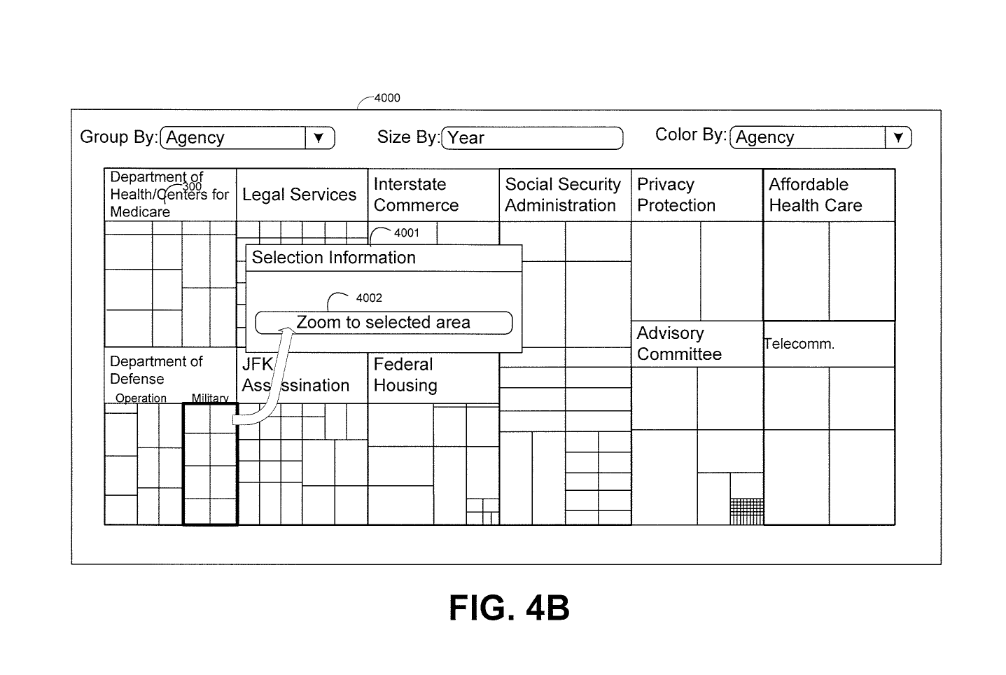

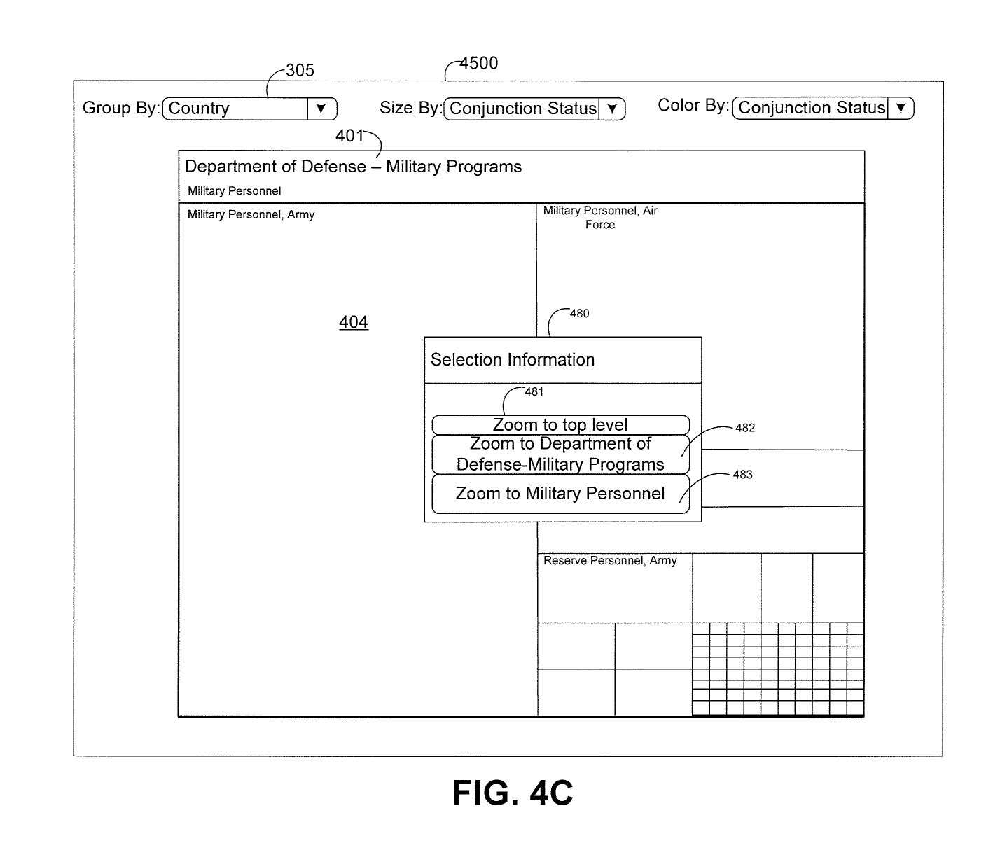

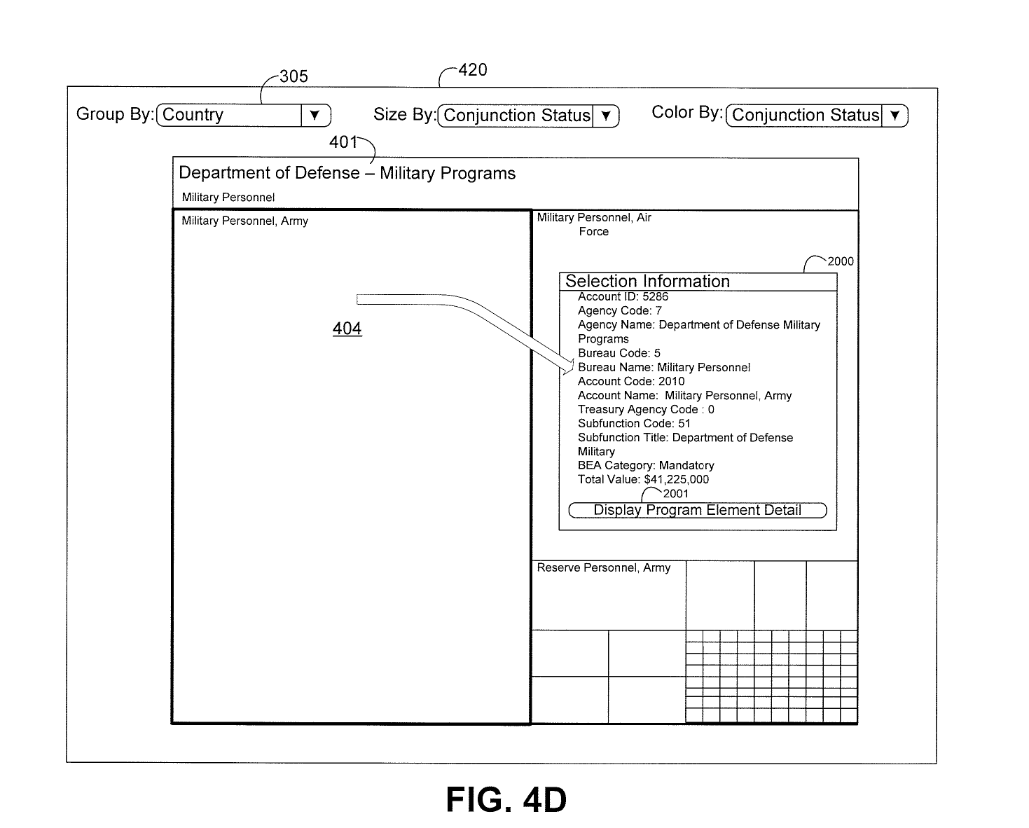

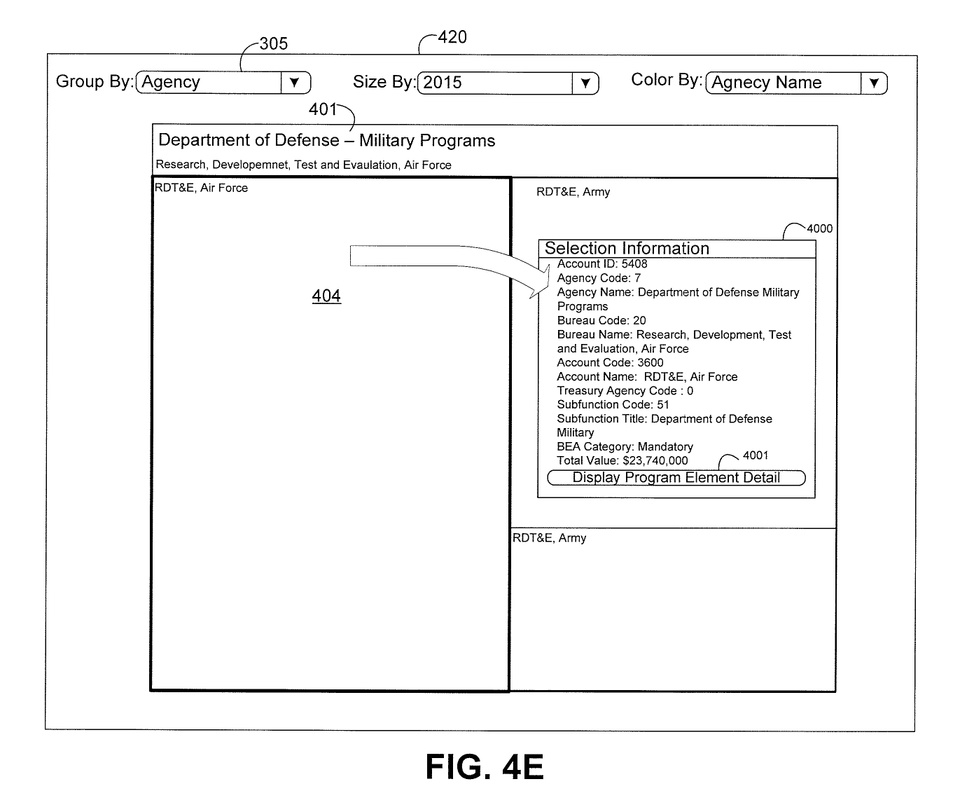

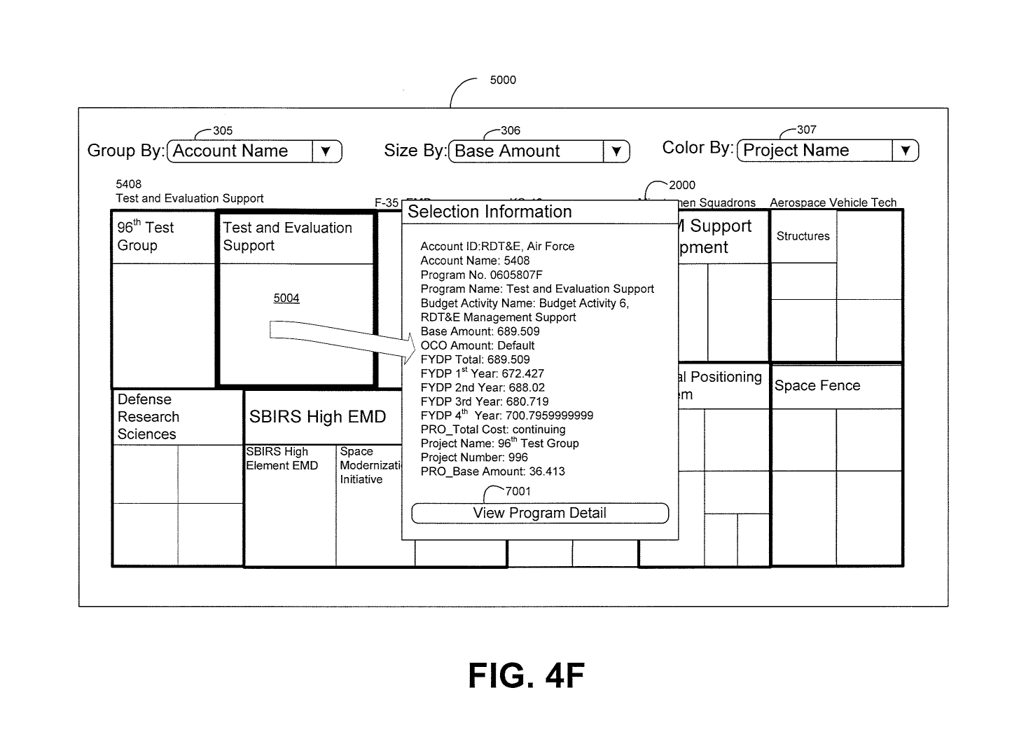

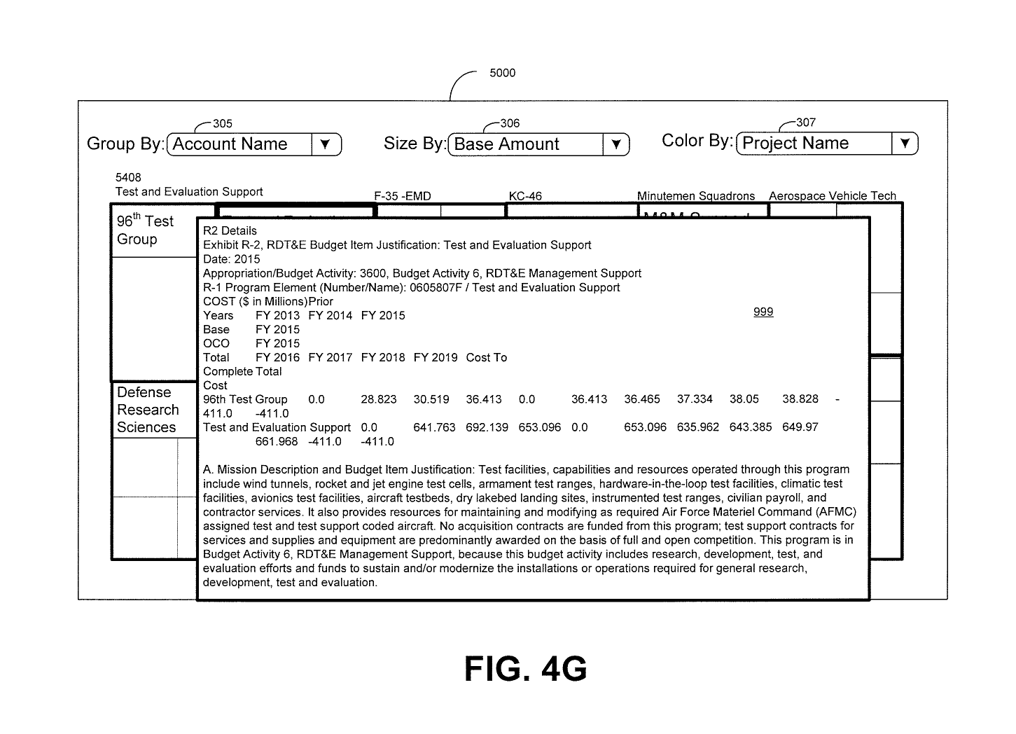

A user 107 may then navigate the program characteristic data via a graphical user interface (GUI) (described with reference to FIGS. 4A-4D) on the control center computing device 101. In this regard, the control center computing device 101 controls visualization of the program characteristic data by receiving program characteristic data selection input from the user, translating the program characteristic data into a plurality of graphical elements, and displaying the graphical elements in the GUI for visual perception by a user of the control center computing device 101. This process is described further herein.

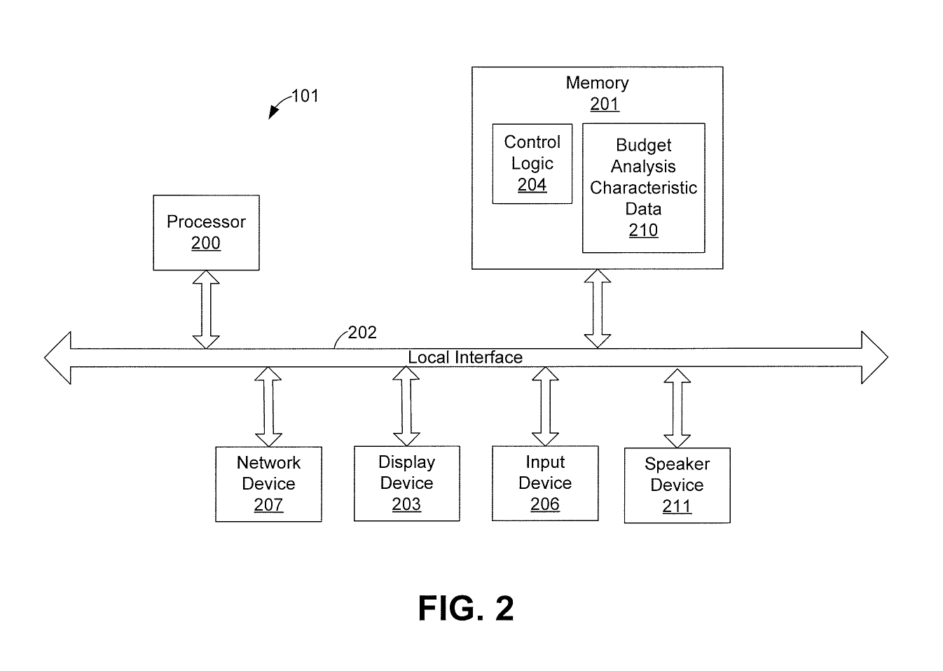

FIG. 2 depicts an exemplary embodiment of the control center computing device 101 of FIG. 1. The device 101 comprises at least one conventional processing element 200, such as a central processing unit (CPU) or digital signal processor (DSP), which communicates to and drives the other elements within the device 101 via a local interface 202. Furthermore, a display device 203, such as, for example, a screen, can be used to visually display budget analysis characteristic data 210 to the user 107 (FIG. 1). Additionally, an input device 206, such as a keypad or keyboard, can be used by the user 107 to input data into the device 101. Also, an input device 206 can be used to input acoustic sound, such as speech, into the system 101, and a speaker 211 can be used to output acoustic sound from the system 101. In addition, the system 100 has a network device 207 for receiving program characteristic data from the budget analysis data server 102 (FIG. 1).

The control center computing device 101 further comprises control logic 204 stored in memory 201 of the system 101. The control logic 204 is configured to establish a data connection with the budget analysis data server 102 (FIG. 1) through the network 103 in order to request or periodically receive program characteristic data from the budget analysis data server 102. Upon receipt, the control logic 204 stores the received program characteristic data 210 in memory 201. Note that the control logic 204 may be software, hardware, or any combination thereof. When implemented in software, the control logic 204 can be stored and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The program characteristic data 210 comprises any data indicative of parameters associated with a particular financial program. In this regard, the budget analysis characteristic data 210 may comprise any data indicative of parameters associated with the PDFs PDF₁-PDFₙ, that are received by the budget information collection system 104. Exemplary data that is parsed by the budget information collection system 104 is provided throughout when discussing the GUI depicted in FIG. 4A-4D.

As mere examples, the budget information collection system 104 (FIG. 1) may receive PDFs regarding names of agencies and their associated budgets. Additionally, the budget information collection system 104 may receive in the related PDFs information related to programs and program data. Other types of data that may be obtained by the budget information collection system 104 in other embodiments related to financial information. The data received may also include any type of data than can be inferred from the PDFs data.

This information may be provided to the budget analysis data server 102 in real time, and passed on to the central computing device 101 upon request. These are mere examples, and fewer, more, or different budget analysis characteristics data 210 may be provided by the budget analysis data server 102 in other embodiments.

In operation, the control logic 204 translates the budget analysis characteristic data 210 into graphical objects for ease of visualization by the user 107. In this regard, the control logic 204 translates the budget analysis characteristic data 210 into geometric shapes that are grouped, colored, and scaled to denote the budget analysis characteristic data 210.

As an example, the user 107 may desire to view information that conveys groups of budget information related to a particular budget, e.g., the Presidential Budget. In such a scenario, the user 107 selects an agency view of the budget analysis characteristic data 210 via the input device 206, and in response, the control logic 204 translates the budget analysis characteristic data 210 corresponding to each agency into graphical elements and displays the graphical elements to the display device 203. In such a scenario, the control logic 204 queries the database for budget analysis characteristic data 210 based upon the agency, and translates the budget analysis characteristic data returned on the agency query of the budget analysis characteristic data 210 into graphical elements that convey each agency and related accounts associated with each agency.

In one embodiment, the control logic 204 translates the budget analysis characteristic data 210 that identifies agency into a graphical element that is sized based upon the budget analysis characteristic data indicative budget amount associated with each agency. For example, the larger the budget relative to other budgets the larger the graphical element.

In one embodiment, the budget analysis data server 102 is updated in real time. Additionally, the central computing device 101 requests periodic updates, e.g., every five minutes, of the budget characteristic data 210. Thus, the central computing device 101 is capable of displaying to the user 107 in near real time updates budget analysis characteristic data 210.

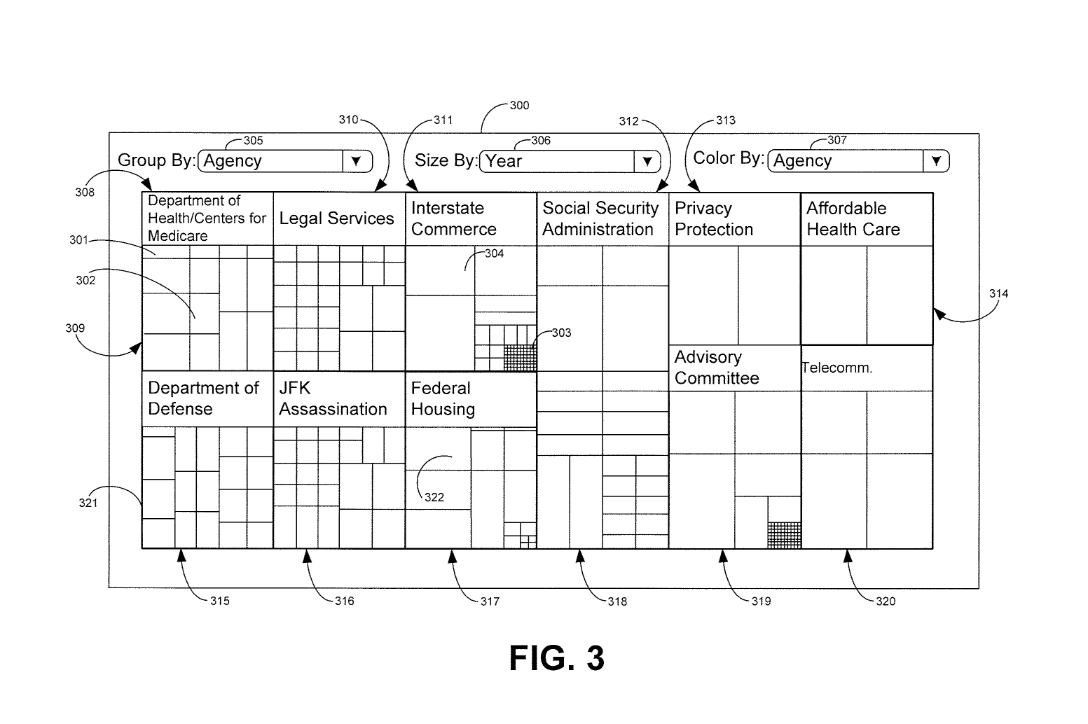

FIG. 3 depicts an exemplary graphical user interface (GUI) 300 in accordance with an embodiment of the present disclosure. In one embodiment, the control logic 204 (FIG. 2) comprises a Home GUI (not shown) that displays a number of view selections from which the user 107 (FIG. 1) may select to determine how the control logic 204 translates and displays the budget analysis characteristic data 210 (FIG. 2). As mere examples, the Home GUI may comprise view selections comprising of a “Group By” pulldown menu in which the user may select Agency Name/Bureau name, account name, title, treasury agency code, and on- or off-budget.

The exemplary GUI 300 comprises a “Group by” pulldown menu 305, a “Size By” pulldown menu 306, and a “Color By” pulldown menu 307. In addition, the GUI 300 comprises a budget analysis characteristic data pane 308 in which the control logic 204 displays graphical elements translated from the budget analysis characteristic data 210. Which budget analysis characteristic data 210 that the control logic 204 translates and displays into particular graphical elements in the pane 308 depends upon the user's view selection from the Home GUI.

In the embodiment depicted, the control logic 204 translates the budget analysis characteristic data 210 into quadrilaterals; however, the control logic 204 may translate the budget analysis characteristic data 210 into other shapes in other embodiments.

The “Group By” pulldown menu 305 may comprise a number of selection options. In one embodiment, when the user 107 selects the “Group By” pulldown menu 305, the control logic 204 provides optional selections, including selections for “Agency Name,” “Account Name,” “Subfunction Title,” “Treasury Agency Code,” and “On- or Off-Budget.” Note that these optional selections are not limiting. Further note that in one embodiment, the available optional selections may be configured by the user 107. In this regard, any budget analysis characteristic data 210 may be used as an optional selection in the “Group By” pulldown menu as configured by the user 107. Depending upon the selection from the user 107, the control logic 204 translates the budget analysis characteristic data 210 dependent upon the selection and displays geometric shapes grouped by the selection made by the user 107. The size of the graphical element visually display the amount of money associated with the “Group by” selected by the user.

In response to selection of “Account” from the pulldown menu 305, the control logic 204 translates the budget analysis characteristic data 210 into graphical elements grouped by the Account name. In response to selection of “Subfunction Title” from the pulldown menu 305, the control logic 204 translates the budget analysis characteristic data 210 into graphical elements grouped by the subfunction. In response to selection of “Treasury Agency Code” from the pulldown menu 305, the control logic 204 translates the budget analysis characteristic data 210 into graphical elements grouped by treasury agency code. In response to selection of “On- or Off-Budget” from the pulldown menu 305, the control logic 204 translates the budget analysis characteristic data 210 into graphical elements grouped by any financial information that is included or not included in the budget.

The “Size By” pulldown menu 306 may also comprise a number of selection options. In one embodiment, when the user 107 selects the “Size By” pulldown menu 306, the control logic 204 provides optional selections, including selections for a year in which the user 107 desires to analyze budget analysis data 210. In response, the control logic 204 displays graphical elements related to the year selected in the budget being analyzed e.g., the United Stated Federal Budget.

The “Color By” pulldown menu 307 may also comprise a number of selection options. In this regard, the user 107 may select a particular parameter for which he/she desires to exhibit identifying colors for conveying particular budget analysis characteristic data 210. In one embodiment, when the user 107 selects the “Color By” pulldown menu 307, the control logic 204 provides optional selections, including selections for “Agency Name,” “Account Name,” “Subfunction Title,” “on- or -off Budget”, and “Treasury Agency Code. Note that these optional selections are not limiting. Further note that in one embodiment, the available optional selections may be configured by the user 107. In this regard, any budget analysis characteristic data 210 may be used as an optional selection in the “Color By” pulldown menu as configured by the user 107.

In response to selection of “Agency Name” from the pulldown menu 307, the control logic 204 translates the budget analysis characteristic data 210 corresponding to the agency into graphical elements wherein each agency exhibits a different color. This allows easier discernment of the budget analysis associated with agency. In response to selection of “Account name” from the pulldown menu 307, the control logic 204 translates the budget analysis characteristic data 210 corresponding to the account of the plurality of budget analysis into graphical elements wherein budget analysis characteristics having similar account names exhibit similar colors. In response to selection of “Subfunction Title” from the pulldown menu 307, the control logic 204 translates the budget analysis characteristic data 210 corresponding to the subfunction title into graphical elements wherein each graphical element having similar budget analysis subfunction titles are colored similarly. In response to selection of “On- or Off-Budget” from the pulldown menu 307, the control logic 204 translates the budget analysis characteristic data 210 corresponding to the what line items are on the budget or off the budget colored differently for ease in visual perception. In response to selection of “Treasurer Agency Code” from the pulldown menu 307, the control logic 204 translates the budget analysis characteristic data 210 corresponding to the treasury codes into graphical elements wherein similar treasury codes are colored similarly.

As noted hereinabove, the user 107 may select a particular view from the Home GUI (not shown). In one embodiment, the user 107 may select the following views: Agency Name, Account Name, Subfunction Title, Treasury Agency Code, or On- or -Off Budget Each particular view conveys different instantiations of the budget analysis characteristic data 210.

In the Agency view, the GUI 300 comprises the window pane 308 that displays the translated budget analysis characteristic data 210. The control logic 204 translates budget analysis characteristic data 210 related to each agency, and displays the geometric shapes corresponding to each of the agencies sized according to the amount of the agencies budget. The graphical element pane 308 comprises a plurality of blocks 309-320, wherein each block 309-320 corresponds to a particular agency and a particular color. Within each block 309-320 is one or more of sub-blocks 301-304. Note that every sub-block is not identified with a reference numeral for ease of description and explanation; however, the control logic 204 translates the budget analysis characteristic data 210 into geometric shapes, wherein at least a portion of budget analysis identified in the budget analysis characteristic data 210 is represented.

In the example provided, the block 309 comprises geometric shapes that convey budget analysis financial related to the Department of Health/Centers for Medicare. Within the block 309 is a plurality of sub-blocks 301 and 302 (note that only two of the plurality are referenced for ease of description). In translation of the budget analysis characteristic data 210, the control logic 204 determines a particular size of the budget analysis data 210, and displays geometric shapes that are sized according to a selection by the user 107. As an example, if the user 107 elects to have the size of the geometric shapes be representative of the size of the budget, the control logic 204 translates the budget analysis characteristic data 210 corresponding to the budget analysis size into geometric shapes that reflect the financial budget of the agency identified. In the example provided, block 301 is a particular size, and block 302 is a larger size. Thus, the control logic 204 determines from the budget analysis characteristic data 210 that the budget represented by 302 is bigger than budget represented by 301 and translates representative geometric shapes that convey this size difference, i.e., the sub-block 301 is smaller than the sub-block 302.

As another example, the block 311 comprises geometric shapes that convey information related to the budget of legal services. Within the block 311 is a plurality of sub-blocks 303 and budget analysis (note that only two of the plurality are referenced for ease of description). In translation of the budget analysis characteristic data 210, the control logic 204 determines sizes of the budgets, and displays geometric shapes representative of the relative sizes of the budgets. In this regard, block 304 is a particular size, and block 303 is much smaller in size. Thus, the control logic 204 determines from the budget analysis characteristic data 210 that the budget represented by 304 is bigger than budget represented by 303 and translates the budget analysis characteristic data 210 into representative geometric shapes that convey this size different, i.e., the sub-block 303 is much smaller than the sub-block 304.

Not only does the control logic 204 translate the RS budget analysis O characteristic data into geometric shapes contained within the blocks 309-320 that exhibit relative sizes, the control logic 204 also translates the budget analysis characteristic data 210 into geometric shapes between the blocks 309-320 that exhibit relative sizes. In this regard, budgets associated with the Federal Housing are represented by block 317. The block 317 comprises a sub-block 322 indicative of a budget of a Federal Housing program. In this particular example, the control logic 204 determines that the budget corresponding to sub-blocks 301-304 are smaller than the budgets corresponding to sub-block 322. Thus, the control logic 204 translates the budget analysis characteristic data 210 into geometric shapes whose sizes are representative of the relative size of the budgets between the country blocks 309-320. Notably, the budget analysis represented by the sub-block 322 is larger than the budget analysis represented by the sub-blocks 301-304; therefore, the sub-block 322 is larger than the sub-blocks 301-304.

Note that the control logic 204 translates a first parameter of the budget analysis characteristic data 210 into blocks, as described. As an example, each block may represent a budget of the agency, which is the first parameter of budget analysis characteristic data 210. Further, for each block the control logic 204 translates a second parameter of the budget analysis characteristic data 210 into sub-blocks, wherein data indicative of each generated sub-block is associated with the first parameter. For example, each sub-block may represent a program of the agency identified. Where the first parameter represents an agency and the second parameter represents a budget, the agency may be the origin of a plurality of budgets. Therefore, the control logic 204 would display a block having a plurality of sub-blocks.

Further note that in one embodiment, each sub-block 301-304 represents a single budge. In such an embodiment, a user 107 may desire to view details about the particular budget analysis corresponding to one of the sub-blocks 301-304. If the user 107 so desires, the user 107 may click a single sub-block, and the control logic 204 displays a child window that describes the budget to which the sub-block relates. FIG. 4A depicts an exemplary scenario for displaying such information to the user 107. In the example of FIG. 4A, the user 107 clicks on the sub-block 301. In response to the user input, the control logic 204 displays a child window 400 that contains, for example, data indicative of the budget and other information related to the program, including account identifier, agency code, agency name, bureau code, bureau name, account code, account name, treasury agency code, subfunction code, subfunction title, BEA Category, and total budget amount, which in the example is $342,603,000. Note that the data listed in the child window 400 may contain other types of budget analysis characteristic data 210 in other embodiments, and the above-referenced data is not limiting. In one embodiment, the budget analysis characteristic data 210 that is displayed in the child window 400 is configurable by the user 107, and may include any user-selections of the budget analysis characteristic data 210.

FIG. 4B depicts a GUI 600 wherein the user has selected the military component of the Department of Defense Agency. Upon selection, the control logic 204 displays the child window 4001. Upon selection of the “Zoom to selected area” pushbutton 4002, the control logic 204 displays the GUI 4500 depicted in FIG. 4C. In such a GUI, the control logic 204 translates the budget for the particular program, e.g., Military Personnel, Army, into a graphical element that is sized according to the budget of the particular program.

Upon selection, the control logic displays the child menu 480, that contains a link 481 to the top[level (FIG. 3), a Zoom to Department of Defense-Military Programs pushbutton 482, and a Zoom to Military Personnel pushbutton 483.

With reference to FIG. 4D, if the user selects one of the boxes, i.e., Military Personnel, Army, the control logic 204 displays a child window 2000 containing information related to the Military Personnel, Army. In this regard, the control logic 204 displays an Account ID, and Agency Code, an Agency Name, a Bureau Code, a Bureau Name, an Account code 2010, an Account Name, A Treasury Agency Code, a Subfunction Code, a Subfunction Title, a BEA Category, and a Total Value of the program.

In FIG. 4E, the user has selected the Department of Defense—Military Programs, and drilled down to the Research, Development, Test and Evaluation, Air Force program. Similar to FIG. 4D, the control logic 204 displays the details related to the particular program upon selection of the graphical element 404. Additionally, the child window 4000 includes a Display Program Element Detail pushbutton 4001.

Upon selection of pushbutton 4001, the control logic 204 displays program information, as is shown in FIG. 4F. This may include a number of groups that are covered under the RDT&E, Air Force graphical element 404 in FIG. 4E. In response, the control logic 204 displays the various groups under RDT&E, Air Force. These groups include 96^{th} Test Groups, Test and Evaluation Support, and others.

When a subblock 5004 is selected, the control logic 204 displays information related to the actual program, which includes Account ID, Account Name, Program Number, Program Name, Budget Activity Name, Base Amount, OCO Amount, FYDP 1^{st} Year amount, FYDP 2^{nd} year amount, FYDP 3^{rd} year amount, and FYDP 4^{th} year amount, PRO_Total Cost, Project Name, Project Number, and PRO_Base Amount.

The user may also select the View Program Detail pushbutton. In response, the control logic 204 displays a text box 999 in FIG. 4D. The text box displays all the program details for the user 107 to peruse to determine if the user is interested in a particular program.

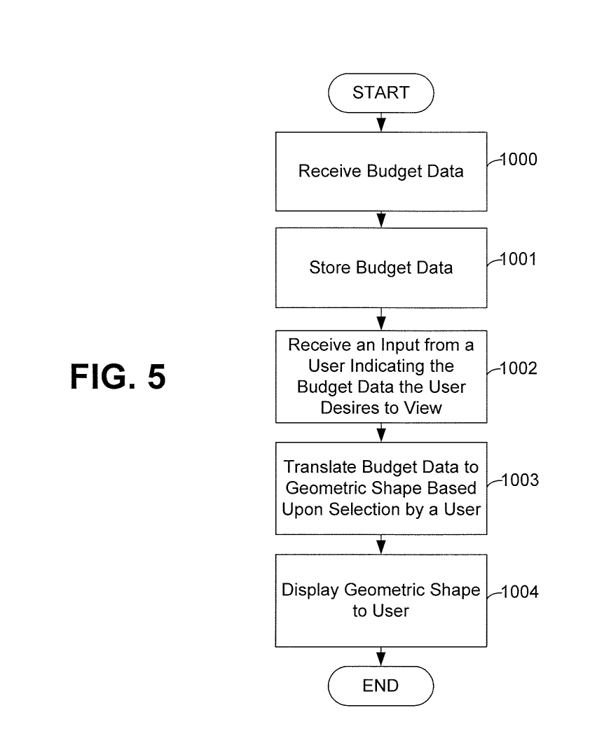

FIG. 5 is a flowchart illustrating exemplary architecture and functionality of the control logic 204 described hereinabove.

In block 1000, the control logic 204 (FIG. 2) receives budget analysis data from a budget information system 104 (FIG. 1). The budget analysis data comprises budget analysis characteristic data 210 (FIG. 2) indicative of budgets of particular programs in governmental agencies that are being tracked by the budget information collection system 104. The control logic 204 stores the budget analysis data received as indicated in block 1001.

In block 1002, the control logic 204 receives an input from a user 107 (FIG. 1) indicating what budget analysis characteristic data 210 the user 107 desires to view. As noted herein, the user may desire to view “Group By” data, “Size By” data, or “Color By” data.

In response to the user selection, the control logic 204 translates budget analysis characteristic data 210 into geometric shapes in block 1003. In one embodiment, the control logic 204 translates the budget analysis characteristic data 210 to a plurality of quadrilaterals, wherein the size and color of the quadrilaterals convey information about the agency programs corresponding to the budget analysis characteristic data 210. In block 1004, the control logic 1004 displays the plurality of quadrilaterals to a display device 203 (FIG. 2).

What is claimed is:

1. A system, comprising:
a budget analysis data server communicatively coupled to an budget analysis collection system; and
a process configured for receiving budget analysis characteristic data from the budget analysis collection system and storing the budget analysis characteristic data in resident memory, the processor further configured for receiving an input from a user identifying budget analysis characteristic data the user desires to view, the logic further configured for translating the budget analysis characteristic data into at least one geometric shape based upon the user's input and displaying the at least one geometric shape to an output device.

2. The system of claim 1, wherein the geometric shape is a quadrilateral.

3. The system of claim 1, wherein the logic translates the budget analysis characteristic data into the geometric shape wherein a size of the geometric shape is indicative of the budget analysis characteristic data.

4. The system of claim 1, wherein the processor translates the budget analysis characteristic data into the geometric shape wherein a color of the geometric shape is indicative of the budget analysis characteristic data.

5. The system of claim 1, wherein the user input is indicative of a governmental agency.

6. The system of claim 7, wherein the processor is further configured to display a color of the geometric shape that indicates a budget size.

7. The system of claim 1, wherein the processor is further configured for translating the budget analysis characteristic data into a block representing one parameter of the budget analysis characteristic data.

8. The system of claim 7, wherein the processor is further configured for translating the budget analysis characteristic data into one or more sub-blocks, wherein each sub-block represents a second parameter of the budget analysis characteristic data, and the second parameter is associated with the first parameter.

9. The system of claim 8, wherein the sub-blocks are visually displayed associated within the block.

10. The system of claim 9, wherein the block has a first size, and the sub-blocks each have a second size.

11. The system of claim 10, wherein the processor is further configured for:
receiving a selection of the block from the user;
translating budget analysis characteristic data corresponding to the first parameter and the first block into a block geometric shape having a size different that the first size;
translating budget analysis characteristic data corresponding to the second parameters and the sub-blocks into sub-block geometric shapes having sizes different from the second sizes; and
displaying the sub-block geometric shapes associated with the block geometric shape.

12. A method, comprising:
receiving, by a budget analysis data server, budget analysis characteristic data from a budget analysis collection system communicatively coupled to the budget analysis data server;
storing the budget analysis characteristic data in resident memory;
receiving an input from a user identifying budget analysis characteristic data the user desires to view;
translating the budget analysis characteristic data into at least one geometric shape based upon the user's input; and
displaying the at least one geometric shape to an output device.

13. The method of claim 12, wherein the translation further comprises translating the budget analysis characteristic data to a quadrilateral.

14. The method of claim 12, further comprising translating the budget analysis characteristic data into the geometric shape wherein a size of the geometric shape is indicative of the budget analysis characteristic data.

15. The method of claim 12, further comprising translating the budget analysis characteristic data into the geometric shape wherein a color of the geometric shape is indicative of the budget analysis characteristic data.

16. The method of claim 15, wherein the displaying further comprising displaying a color of the geometric shape that indicates the potential collision.

17. The method of claim 12, further comprising translating the budget analysis characteristic data into a block representing one parameter of the budget analysis characteristic data.

18. The method of claim 17, further comprising translating the budget analysis characteristic data into one or more sub-blocks, wherein each sub-block represents a second parameter of the budget analysis characteristic data, and the second parameter is associated with the first parameter.

19. The method of claim 18, further comprising visually displaying the sub-blocks in association with the block.

20. The method of claim 19, wherein the block has a first size, and the sub-blocks each have a second size and further comprising:
receiving a selection of the block from the user;
translating budget analysis characteristic data corresponding to the first parameter and the first block into a block geometric shape having a size different that the first size;
translating budget analysis characteristic data corresponding to the second parameters and the sub-blocks into sub-block geometric shapes having sizes different from the second sizes; and
displaying the sub-block geometric shapes associated with the block geometric shape.
